(19) United States
(12) Patent Application Publication
(10) Pub. No.: US 2008/0172683 A1
(43) Pub. Date: Jul. 17, 2008

(54) Disk drive and printer

(75) Inventor: Kazunori Suenaga, Kitakyushu-shi (JP)

Correspondence Address: Edwards Angell Palmer & Dodge LLP, P.O.Box 55874, Boston, MA, 02205, US

(73) Assignee: Seiko Epson Corporation, Tokyo (JP)

(21) Appl. No.: 12/008,300

(22) Filed: Jan. 10, 2008

(30) Foreign Application Priority Data
Jan. 15, 2007 (JP) 2007-005416

(51) Int. Cl. G11B 17/03

(52) U.S. Cl. 720/601

(57) ABSTRACT

A disk drive includes: a disk tray having a disk loading surface on the top; a moving mechanism that guides the disk tray between a disk-tray housing position in the casing and a disk loading position outside the casing; and a grounding support section having a grounding member that comes into contact with a grounding surface below the disk tray to support the disk tray when the disk tray is brought into the disk loading position by the moving mechanism.

The entire disclosure of Japanese Patent Application No. 2007-005416, filed Jan. 15, 2007 is expressly incorporated by reference herein.

### BACKGROUND

1. Technical Field

The present invention relates to disk drives and printers.

2. Related Art

For example, a disk drive equipped with a tray having a tiltable piece at the end of a disk tray main body with a joint (for example, refer to JP-A-2003-296999). This disk drive has a structure in which when the tray is moved to a position at which a disk is loaded or unloaded, the end of the tray piece tilts downward, and when the tray is moved into the casing, the tray piece is guided by guide pieces on both sides thereof, so that the tray main body and the tray piece become flush with each other and are housed into the casing. Thus, clearance is created between the disk and the tray when the disk is taken out, thus facilitating grasping the disk.

Such disk drives, as disclosed in JP-A-2003-296999, do not make sufficient allowance for downward pressure on the tray. Therefore, application of downward pressure may cause troubles such as deflection, deformation, or damage of tray main bodies. Furthermore, in the case where the tray main body has a chucking section for holding a disk on the tray main body, if downward pressure is applied to the tray main body when the user loads a disk, the tray main body may be deflected to hinder the loading.

### SUMMARY

An advantage of some aspects of the invention is to provide a disk drive and a printer in which troubles due to a load from above to the disk tray can be prevented. Another advantage of some aspects of the invention is to provide a disk drive and a printer in which a disk can easily be mounted on a chucking section.

A disk drive according to a first aspect of the invention includes: a disk tray having a disk loading surface on the top; a moving mechanism that guides the disk tray between a disk-tray housing position in the casing and a disk loading position outside the casing; and a grounding support section having a grounding member that comes into contact with a grounding surface below the disk tray to support the disk tray when the disk tray is brought into the disk loading position by the moving mechanism.

The disk drive allows the disk tray having a disk loading surface on the top to be moved between a disk-tray housing position in the casing and a disk loading position on which the disk is to be loaded; and when the disk tray is brought into the disk loading position, the grounding support section comes into contact with a grounding surface below the disk tray to support the disk tray. In this way, when the disk is loaded on the disk tray, the grounding support section is in contact with the grounding surface to support the disk tray. Thus, troubles due to a load from above can be prevented. If the disk tray has a chucking section for holding a disk, the grounding support section supports the disk tray from below by contact with the grounding surface, thus facilitating loading the disk on the chucking section. Here, examples of the “disk” are disks having a central circular hole and circular disks in rectangular cases.

In this case, it is preferable that the grounding support section include a grounding mechanism having the grounding member, wherein when the disk tray is in the housing position, the grounding mechanism fixes the grounding member to the lower surface of the disk tray, and when the disk tray is in the disk loading position, the grounding mechanism fixes the grounding member to the grounding surface. With this structure, when the disk tray is in the disk loading position, the grounding member is grounded to support the disk tray, and when the disk tray is in the housing position, the grounding member is fixed to the lower surface of the disk tray so that both the grounding member and the disk tray are housed in the casing, allowing the disk drive to be made compact. The grounding mechanism may be configured to move the grounding member from the disk tray to the grounding surface as the disk tray is moved from the housing position to the disk loading position by the moving mechanism. The grounding mechanism may include a first support member one end of which is rotatably fixed to the lower surface of the disk tray and the other rotatable end of which has the grounding member; and a second support member shorter than the first support member and having a connecting end connected to the rotatable end of the first support member and a moving end disposed so as to move along the lower surface of the disk tray. With this structure, when the moving end of the second support member comes close to the fixed end of the first support member, the grounding member moves to the lower surface of the disk tray, and when the moving end separates from the fixed end, the grounding member moves to the grounding surface. This allows the grounding member to be moved with a relatively simple structure. In this case, the grounding mechanism may include a first urging section that urges at least one of the first and second support members to the grounding surface; and a second urging member that urges at least one of the first and second support members to the lower surface of the disk tray when the disk tray is in the housing position. With this structure, with the disk tray in the housing position, the grounding member is urged to the lower surface of the disk tray by the second urging member, and with the disk tray in the disk loading position, the grounding member is urged to the grounding surface by the first urging section. This allows the grounding member to be moved according to the position of the disk tray without user's operation. In this case, the disk drive may be configured such that the moving mechanism includes a guide movable between the interior and the outside of the casing so as to guide the disk tray between the interior and the outside of the casing; the fixed end of the first support member is rotatably disposed at a first end of the guide adjacent to the casing; the moving end of the second support member is disposed at a second end of the guide so as to be movable to the fixed end; and the second urging member is disposed at the disk tray and, when the disk tray moves from the disk loading position to the housing position, urges the first and second support members to the lower surface of the disk tray by urging the moving end of the second support member to the fixed end of the first support member. With this structure, the grounding member moves between the lower surface of the disk tray and the grounding surface with the movement of the disk tray. This allows the disk tray to be moved relatively smoothly. As an alternative, the disk drive may be configured such that the moving mechanism include a guide movable between the interior and the outside of the casing so as to guide the disk tray between the interior and the outside of the casing; the fixed end of the first support member is rotatably disposed at the second end of the disk tray; the moving end of the second support member is disposed at the first end of the disk tray so as to be movable to the fixed end; and the second urging member is disposed at the guide and, when the disk tray moves from the disk loading position to the housing position, urges the first and second support members to the lower surface of the disk tray by urging the moving end of the second support member to the fixed end of the first support member.

The disk drive may be configured such that the disk tray includes a chucking section that holds the disk; and the grounding support section is configured such that the grounding member comes to a position vertically below the chucking section when the disk tray is in the disk loading position. With this structure, even if, when a disk is loaded on the chucking section, the disk tray and the disk are pushed from above, the grounding member can securely support the disk tray, thus facilitating loading the disk on the chucking section.

The disk drive may be configured such that the moving mechanism includes a guide that guides the disk tray between the interior and the outside of the casing and a guide support member that rotatably supports the guide so that the second end of the disk tray moves to the grounding surface. This structure allows the disk tray to be grounded with a relatively simple structure.

The disk drive may be configured such that the moving mechanism is a guide that guides the disk tray from the interior of the casing to the grounding surface. This structure allows the disk tray to be grounded with a relatively simple structure.

The disk drive in which the second end of the disk tray moves toward the grounding surface may be configured such that the grounding support section is a bezel having the grounding member at the second end of the disk tray. This structure can stabilize the disk drive because a load on the disk tray from above can be received by the second end of the disk tray. In this case, the bezel may be rotatable about a rotation shaft at the second end of the disk tray so that the outer surface of the bezel that is exposed to the outside when the disk tray is in the housing position comes into contact with the grounding surface when the disk tray comes to the disk loading position. This structure can sufficiently receive a load from above because the outer surface of the bezel is in contact with the ground when the disk tray is in the disk loading position.

The disk drive may be configured such that the grounding support section is a grounding roller in which the grounding member crawls over the grounding surface. This structure prevents the grounding member from being caught by the grounding surface, allowing the disk tray to be supported relatively securely.

The disk drive may be configured such that the grounding support section includes a first pushing member that pushes the grounding member against the grounding surface; and a second pushing member that pushes the grounding member to the lower surface of the disk tray by the moving mechanism when the disk tray is in the housing position. With this structure, with the disk tray in the housing position, the grounding member is pushed to the lower surface of the disk tray by the second pushing member, and with the disk tray in the disk loading position, the grounding member is pushed to the grounding surface by the first pushing member. This allows the grounding member to be moved according to the position of the disk tray without user's operation.

A printer according to a second aspect of the invention includes: one of the above-described disk drives; and a print processing unit that can print data read from a disk loaded on the disk drive to a print medium. Since the above-described disk drive can prevent troubles due to a load from above, the printer equipped with the disk drive offers the same advantages.

### BRIEF DESCRIPTION OF THE DRAWINGS

The invention will be described with reference to the accompanying drawings, wherein like numbers reference like elements.

FIG. 1 is a schematic diagram of a printer according to an embodiment of the invention.

FIG. 2A is a side view of a disk drive of the printer 20.

FIG. 2B is a bottom view of the disk drive of FIG. 2A.

FIG. 3 is a schematic diagram of a grounding support section disposed under a disk tray.

FIG. 4A is a diagram of the disk drive in which the disk tray is in a loading position.

FIG. 4B is a diagram of the disk drive in which the disk tray is moving to a housing position.

FIG. 4C is a diagram of the disk drive in which the disk tray and the guide are moving to the housing position.

FIG. 4D is a diagram of the disk drive in which the disk tray and the guide are in the housing position.

FIG. 5A is a diagram of another disk drive in which the disk tray is in a loading position.

FIG. 5B is a diagram of the disk drive in which the disk tray is moving to a housing position.

FIG. 5C is a diagram of the disk drive in which the disk tray and the guide are moving to the housing position.

FIG. 5D is a diagram of the disk drive in which the disk tray and the guide are in the housing position.

FIG. 6A is a diagram of another disk drive in which the disk tray is in a loading position.

FIG. 6B is a diagram of the disk drive in which the disk tray is in a housing position.

FIG. 7A is a diagram of another disk drive in which the disk tray is in a loading position.

FIG. 7B is a diagram of the disk drive in which the disk tray is moving.

FIG. 7C is a diagram of the disk drive in which the disk tray is in a housing position.

FIG. 8 is a sectional view of the disk drive taken along the line VIII-VIII of FIG. 7A.

### DESCRIPTION OF EXEMPLARY EMBODIMENTS

Best mode of the invention will be described with reference to the embodiments below.

### Embodiments

### First Embodiment

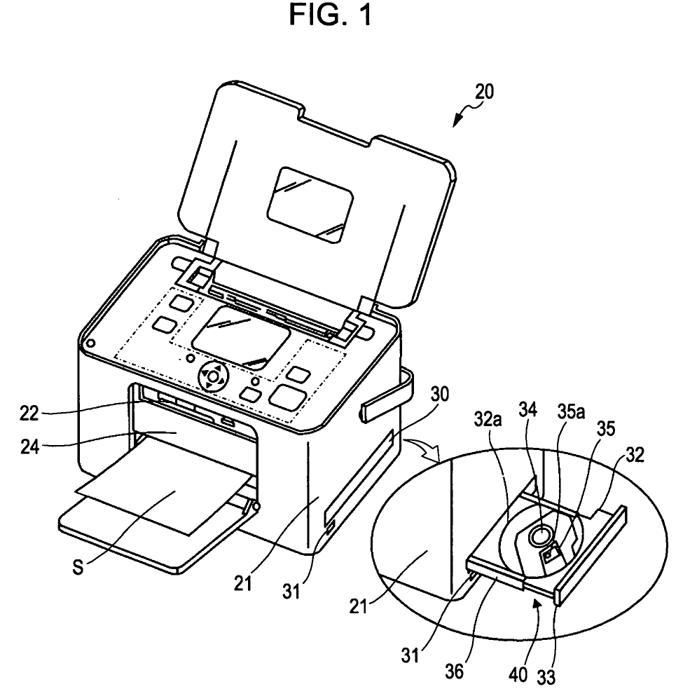

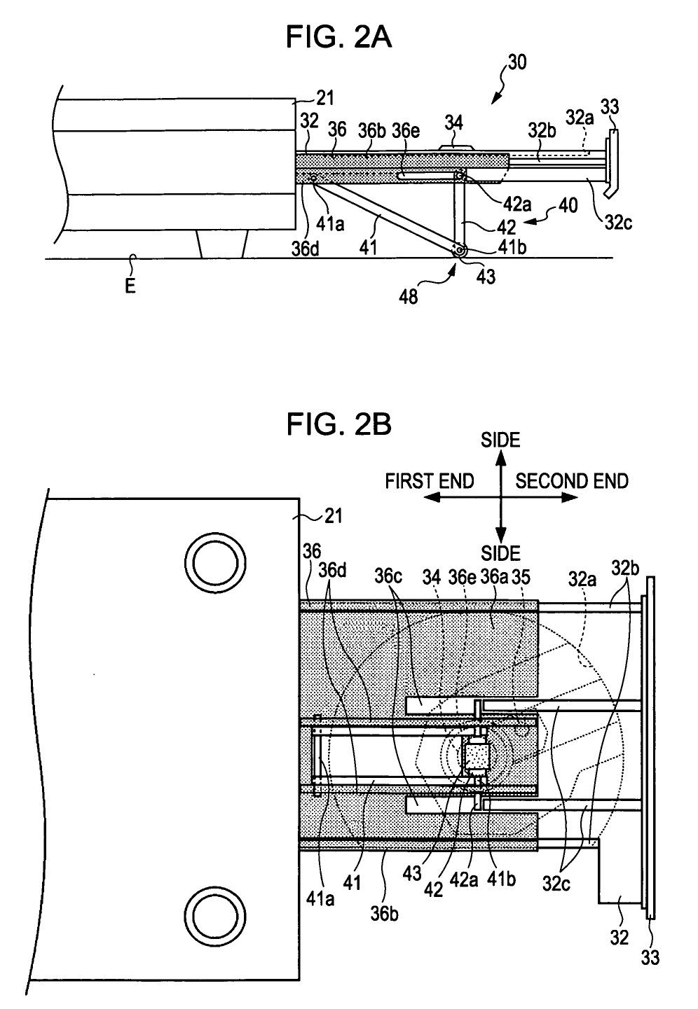

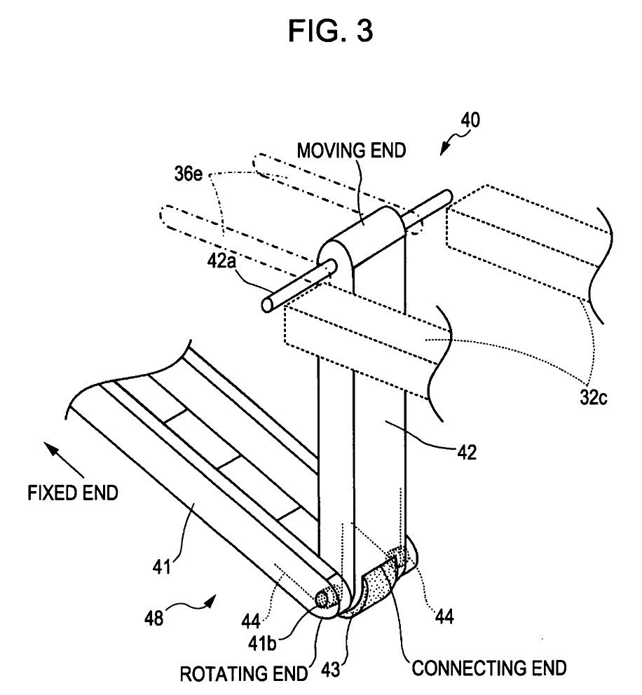

Best mode of the invention will be described with reference to a first embodiment. FIG. 1 is a schematic diagram of a printer 20 according to an embodiment of the invention. FIGS. 2A and 2B illustrate a disk drive 30 of the printer 20, wherein FIG. 2A is a side view, and FIG. 2B is a bottom view of the disk drive of FIG. 2A. FIG. 3 is a schematic diagram of a grounding support section 40 at the lower surface of the disk tray 32 of the disk drive 30. As shown in FIG. 1, the printer 20 of this embodiment has a card slot 22 at the front of the casing 21, through which a memory card, or a portable storage medium, can be loaded or unloaded, the disk drive 30 on the side of the casing 21, which can write or erase data to/from an optical disk such as a DVD-R, and a print mechanism 24 that print data read by the disk drive 30 or from the card slot 22 onto recording paper S. The print mechanism 24 adopts an ink jet system in which piezoelectric elements in a print head is deformed under voltage to apply pressure to the ink in the ink cartridge, thereby ejecting the ink to the recording paper S. The print mechanism 24 may also adopt a system in which the ink in the ink cartridge is pressurized by the heat of the heater in the print head onto the recording paper S, or an electrophotographic print mechanism.

The disk drive 30 is used for backing up data stored in a memory card inserted into the card slot 22 or reading data stored in an optical disk and printing it. The disk drive 30 has a disk tray 32 having a bezel 33, or a lid, at the end, and an optical-disk loading surface 32a on the top, a chucking section 34 disposed on the disk tray 32, for rotatably holding an optical disk, a pickup section 35 disposed on the disk tray 32, for reading the optical disk held by the chucking section 34 with a lens 35a, a guide 36 for guiding the disk tray 32 between a housing position in the casing 21 and a disk loading position projecting from the casing 21, and the grounding support section 40 that supports the disk tray 32, below the disk tray 32 when the disk tray 32 is in the disk loading position.

As shown in FIG. 2, the disk tray 32 is a plate-like member having on the top the loading surface 32a on which a circular disk having a circular hole in the center is to be placed. On both sides of the loading surface 32a, frames 32b thinner than the tray main body are provided. The disk tray 32 has two erect pushing sections 32c fixed to the lower surface, the pushing sections 32c extending from the end to the center of the disk tray 32 in the moving direction of the disk tray 32. The disk tray 32 has a locking mechanism (not shown). When an open switch 31 on the casing 21 and below the disk tray 32 is pushed down by the user, the locking mechanism is cancelled. An optical disk is held by the chucking section 34 in such a manner as to be floated on the disk tray 32. This state is also included in “An optical disk is loaded on the disk tray 32” of this specification. Furthermore, in this specification, the housing position to which the disk tray 32 moves is referred to as “a first end” and the disk loading position to which the disk tray 32 moves is referred to as “a second end”, for the convenience of description.

The guide 36 is a member that guides the disk tray 32 horizontally between the disk loading position and the housing position while supporting the frames 32b on both sides of the disk tray 32. The guide 36 has a bottom plate 36a under the disk tray 32 and guide sections 36b disposed on both sides of the bottom plate 36a, for supporting the frames 32b movably. For the convenience of description, the guide 36 is shown in halftone. The guide 36 is provided in the casing 21 so as to move along a guide groove (not shown) of the casing 21 in the same direction as the moving direction of the disk tray 32, and is always urged from the casing 21 externally by a spring (not shown). The lower surface of the guide 36 has two parallel erect walls 36d in parallel to and inside the pushing sections 32c from the first end to the second end. The two erect walls 36d each have a guide groove 36e in the moving direction of the disk tray 32. The second ends of the guide grooves 36e are configured to be located at a position vertically below the chucking section 34 when the disk tray 32 is in the disk loading position. The lower surface of the guide 36 has rectangular cut portions 36c from the second end to the first end. The pushing sections 32c fixed to the disk tray 32 can be moved along the cut portions 36c.

Referring to FIGS. 2 and 3, the grounding support section 40 is disposed on the lower surface of the disk tray 32. The grounding support section 40 includes a grounding mechanism 48 having a first member 41 and a second member 42 serving as supporter, a grounding roller 43 serving as a grounding member, and a spring 44 serving as an urging member. The first member 41 is substantially in U-shape in cross section orthogonal to the moving direction of the disk tray 32. The fixed end of the first member 41 is disposed on the lower surface of the guide 36 so as to be rotatable about a rotation shaft 41a. The other rotating end of the first member 41 has the grounding roller 43 about a rotation shaft 41b (see FIG. 3). The second member 42 is a columnar member shorter than the first member 41. The connecting end of the second member 42 connects to the rotation shaft 41b of the first member 41. A moving shaft 42a at the other moving end of the second member 42 passes through the guide grooves 36e in the erect walls 36d so as to move to the fixed end of the first member 41 along the lower surface of the disk tray 32. As shown in FIG. 2B, the moving shaft 42a is longer enough than the widths of the erect walls 36d and is supported in the guide grooves 36e so as to project from the erect walls 36d to both sides. The ends of the pushing sections 32c can come into contact with the both ends of the moving shaft 42a (see FIG. 3). The grounding mechanism 48 will next be described. The length of the first member 41 is set so that when the moving shaft 42a of the second member 42 is located at the second ends of the guide grooves 36e, the second member 42 becomes orthogonal to the grounding surface E. The length of the second member 42 is set such that the length between the moving shaft 42a and the rotation shaft 41b is shorter than that between the rotation shaft 41a and the rotation shaft 41b and when it comes at right angles to the grounding surface E, the grounding roller 43 comes into contact with the grounding surface E. Therefore, when the disk tray 32 is in the disk loading position, the second member 42 is at right angles to the grounding surface E, and as the moving shaft 42a moves to the rotation shaft 41a, the grounding roller 43 moves toward the lower surface of the disk tray 32. The grounding roller 43 has an elastic outer circumference (made of rubber or the like) and comes into contact with the grounding surface E. The grounding roller 43 has in the center the rotation shaft 41b, so that it is rotatably supported by the rotating end of the first member 41 and the connecting end of the second member 42. As shown in FIG. 3, the spring 44 is supported about the rotation shaft 41b, whose one end is connected to the first member 41 and the other end is connected to the second member 42, and urges the first member 41 and the second member 42 in the directions apart from each other. Thus, the spring 44 acts on the first member 41 and the second member 42 to urge the grounding roller 43 to the grounding surface E. The urging force of the spring 44 is set slightly lower than that of the spring for urging the guide 36.

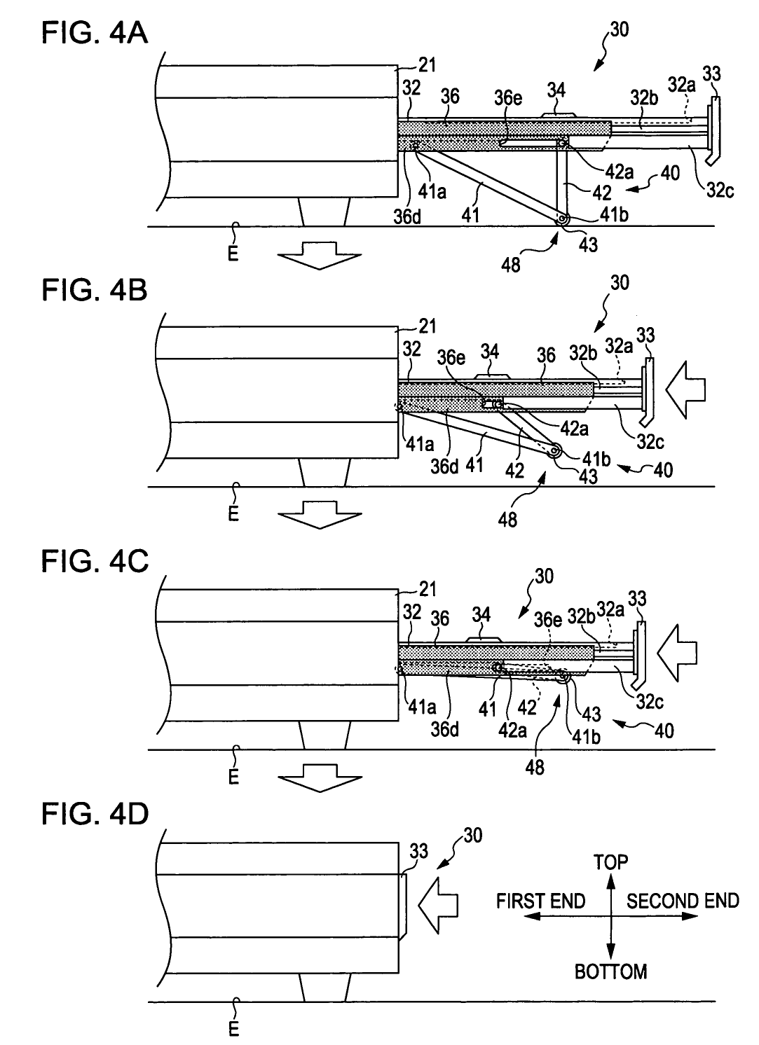

The operation of this disk drive 30, and more particularly, the operation of housing the disk tray 32 from the optical disk loading position into the casing 21 will be described. FIGS. 4A to 4D illustrate the operation of housing the disk tray 32 into the casing 21, wherein FIG. 4A shows the disk drive 30 in which the disk tray 32 is in the disk loading position, FIG. 4B shows the disk drive 30 in which the disk tray 32 is moving to the housing position, FIG. 4C shows the disk drive 30 in which the disk tray 32 and the guide 36 are moving to the housing position, and FIG. 4D shows the disk drive 30 in which the disk tray 32 and the guide 36 are in the housing position. First, the user places an optical disk on the chucking section 34, and pushes the bezel 33 toward the casing 21. Then, the guide 36 moves to the casing 21 until the first member 41 comes into contact with the casing 21, so that the disk tray 32 is moved horizontally by the guide 36 toward the casing. At that time, the ends of the pushing sections 32c come into contact with the moving shaft 42a to push the moving shaft 42a toward the casing 21. Then, as shown in FIG. 4B, the moving shaft 42a moves along the guide grooves 36e toward the rotation shaft 41a, so that the moving end of the second member 42 fixed to the moving shaft 42a is also moved toward the rotation shaft 41a. The first member 41 is lifted by the second member 42, so that its rotating end is moved upward, so that the grounding roller 43 connected thereto is moved from the grounding surface E toward the lower surface of the disk tray 32. Subsequently, when the user pushes the bezel 33 toward the casing 21, the moving shaft 42a pushed by the pushing sections 32c comes into contact with the end of the guide groove 36e adjacent to the casing 21 to fix the grounding roller 43 to the lower surface of the disk tray 32 and the guide 36 moves toward the casing 21 along with the disk tray 32. When the user further pushes the bezel 33 toward the casing 21, the disk tray 32 is fixed in the housing position by the locking mechanism (not shown), with the bezel 33 in contact with the casing 21. On the other hand, to move the disk tray 32 from the housing position to the disk loading position, the user pushes down the open switch 31 to cancel the locking mechanism that fixes the disk tray 32, so that the disk tray 32 and the guide 36 move to the disk loading position by the spring force of the spring that urges the guide 36. At that time, the first member 41 and the second member 42 are urged by the spring 44, so that the grounding roller 43 moves to the grounding surface E. Thus the disk tray 32 reaches the disk loading position and the grounding roller 43 comes into contact with the grounding surface E. At that time, the moving shaft 42a comes into contact with the second ends of the guide grooves 36e vertically below the chucking section 34. Thus, the grounding roller 43 is fixed at a position vertically below the chucking section 34 (see FIG. 4A).

The correspondence between the components of this embodiment and the components of the claims of the invention will be described. The guide 36 of this embodiment corresponds to a moving mechanism, the first member 41 and the second member 42 correspond to a grounding mechanism, the grounding roller 43 corresponds to a grounding member, the first member 41 corresponds to a first support member, the second member 42 corresponds to a second support member, the spring 44 corresponds to a first urging member and a first pushing member, the pushing section 32c corresponds to a second urging member and a second pushing member, and the print mechanism 24 corresponds to a print processing unit.

The disk drive 30 according to the first embodiment has a structure in which the disk tray 32 having on the top the loading surface 32a for loading an optical disk can be moved between a housing position in the casing 21 and an optical disk loading position projecting from the casing 21, and the grounding support section 40 supports the disk tray 32 therebelow by coming into contact with the grounding surface E when the disk tray 32 comes to the disk loading position. Thus, when the disk tray 32 is in the disk loading position, the grounding support section 40 is in contact with the ground to support the disk tray 32. This structure prevents troubles such as the deformation or damage of the disk tray 32 due to downward loads on the disk tray 32. Since the disk tray 32 has the chucking section 34 for holding an optical disk and the moreover the grounding support section 40 is in contact with the grounding surface E to support the disk tray 32 from below, the optical disk can easily be held by the chucking section 34. Furthermore, with the grounding support section 40, when the disk tray 32 is in the disk loading position, the grounding roller 43 is grounded to support the disk tray 32, and when the disk tray 32 is in the housing position, the grounding roller 43 is fixed to the lower surface of the disk tray 32 so that both the grounding roller 43 and the disk tray 32 are housed in the casing 21, allowing the disk drive 30 to be made compact. Furthermore, when the disk tray 32 is in the housing position, the grounding roller 43 is pushed to the lower surface of the disk tray 32 by the pushing sections 32c, and when the disk tray 32 is in the disk loading position, the grounding roller 43 is urged to the ground surface E by the spring 44. This allows the grounding roller 43 to be moved according to the position of the disk tray 32 without user's operation. The fixed end of the first member 41 is rotatably disposed at the first end of the guide 36; the moving end of the second member 42 is disposed at the second end of the guide 36 so as to be movable to the fixed end; and the pushing sections 32c are disposed at the disk tray 32 and, when the disk tray 32 moves from the disk loading position to the housing position, pushes the first and second members 41 and 42 to the lower surface of the disk tray 32 by pushing the moving end of the second member 42 to the fixed end of the first member 41. Thus, the grounding roller 43 moves between the lower surface of the disk tray 32 and the grounding surface E with the movement of the disk tray 32. This allows the disk tray 32 to be moved relatively smoothly. Furthermore, the grounding roller 43 is located vertically below the chucking section 34 when the disk tray 32 is in the disk loading position. This structure allows the grounding member to firmly support the disk tray 32 even if the disk tray 32 and the optical disk are pushed from above when the optical disk is loaded on the chucking section 34, thus facilitating loading the optical disk on the chucking section 34. Furthermore, the grounding member is a grounding roller that crawls over the grounding surface. This structure prevents the grounding member from being caught by the grounding surface E, allowing the disk tray 32 to be supported relatively securely. The printer 20 of this invention is useful because it is frequently used for storing image data.

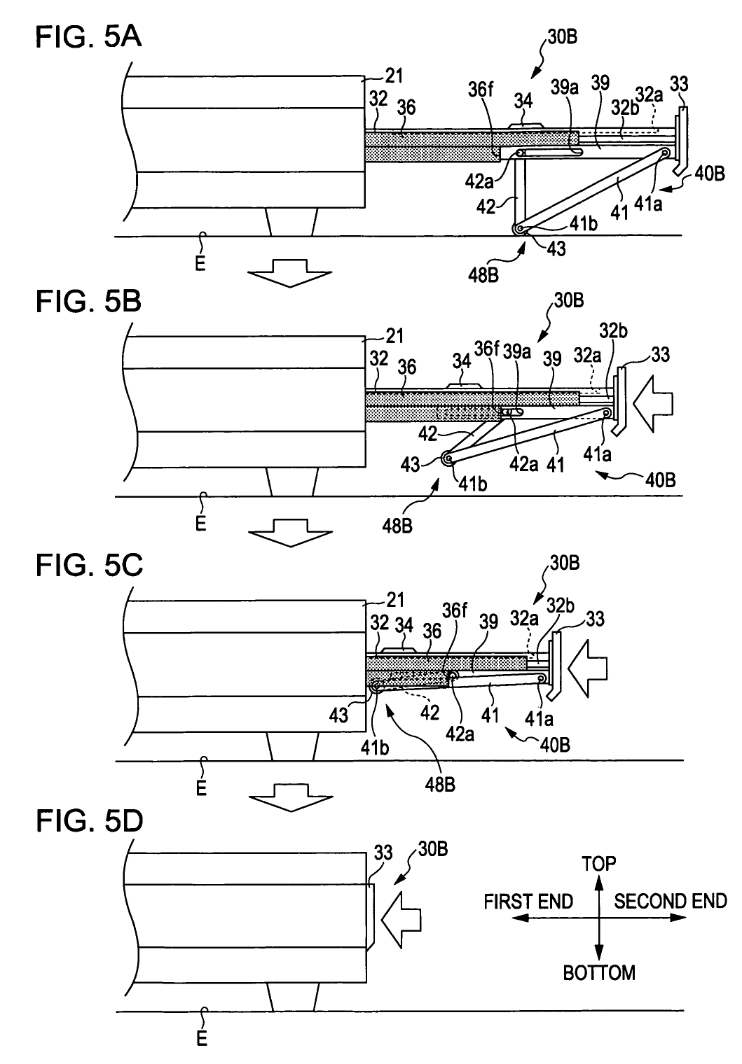

In the first embodiment, the first member 41 is rotatable about the guide 36, and the second member 42 is movable along the guide grooves 36e in the erect walls 36d of the guide 36. As an alternative, a disk drive 30B including a grounding support section 40B may be provided, as shown in FIG. 5. FIGS. 5A to 5D illustrate the operation of the grounding support section 40B, wherein FIG. 5A shows the disk drive 30B in which the disk tray 32 is in the disk loading position, FIG. 5B shows the disk drive 30B in which the disk tray 32 is moving to the housing position, FIG. 5C shows the disk drive 30B in which the disk tray 32 and the guide 36 are moving to the housing position, and FIG. 5D shows the disk drive 30B in which the disk tray 32 and the guide 36 are in the housing position. For the convenience of description, the same components as those of the first embodiment are given the same reference numerals and their description will be omitted here. The grounding support section 40B has a grounding mechanism 48B including the first member 41 and the second member 42, and has two erect walls 39 along the lower surface of the disk tray 32 from the second end to the center of the disk tray 32. The second ends of the erect walls 39 have the fixed end of the first member 41 rotatably attached thereto, and the second ends of the erect walls 39 have guide grooves 39a. The guide grooves 39a support the moving shaft 42a disposed at the moving end of the second member 42 so as to move to the fixed end. A pushing section 36f is disposed along the lower surface of the guide 36. When the disk tray 32 moves from the disk loading position to the housing position, the pushing section 36f pushes the moving end of the second member 42 to the fixed end of the first member 41 so that the first member 41 and the second member 42 are pushed to the lower surface of the disk tray 32. The operation of this disk drive 30B, and more particularly, the operation of housing the disk tray 32 from the optical-disk loading position into the casing 21 will be described. Referring to FIG. 5A, when the user pushes the bezel 33 toward the casing 21, with the disk tray 32 in the disk loading position, the disk tray 32 is moved horizontally by the guide 36 to the casing 21. At that time, the end of the pushing section 36f comes into contact with the moving shaft 42a to push the moving shaft 42a to the second end. Then, as shown in FIG. 5B, the moving shaft 42a is moved along the guide grooves 39a toward the rotation shaft 41a, so that the moving end of the second member 42 fixed to the moving shaft 42a is also moved toward the rotation shaft 41a. Thus, the rotating end of the first member 41 is lifted, so that the connecting end of the second member 42 and the grounding roller 43 connected thereto are moved from the grounding surface E toward the lower surface of the disk tray 32. Subsequently, when the user pushes the bezel 33 toward the casing 21, the moving shaft 42a pushed by the pushing section 36f comes into contact with the second ends of the guide grooves 39b to fix the grounding roller 43 to the lower surface of the disk tray 32 and the guide 36 moves toward the casing 21 along with the disk tray 32. When the user further pushes the bezel 33 toward the casing 21, the disk tray 32 is fixed in the housing position by the locking mechanism (not shown), with the bezel 33 in contact with the casing 21. On the other hand, to move the disk tray 32 to the disk loading position, the user pushes down the open switch 31 to cancel the locking mechanism that fixes the disk tray 32, so that the disk tray 32 and the guide 36 move to the disk loading position by the urging force of the spring that urges the guide 36. At that time, the grounding roller 43 moves to the grounding surface E. Thus the disk tray 32 reaches the disk loading position and the grounding roller 43 comes into contact with the grounding surface E. Thus, when the disk tray 32 comes to the disk loading position, the grounding support section 40B comes into contact with the ground to support the disk tray 32. This structure can thus prevent troubles due to a load on the disk tray 32 from above.

### Second Embodiment

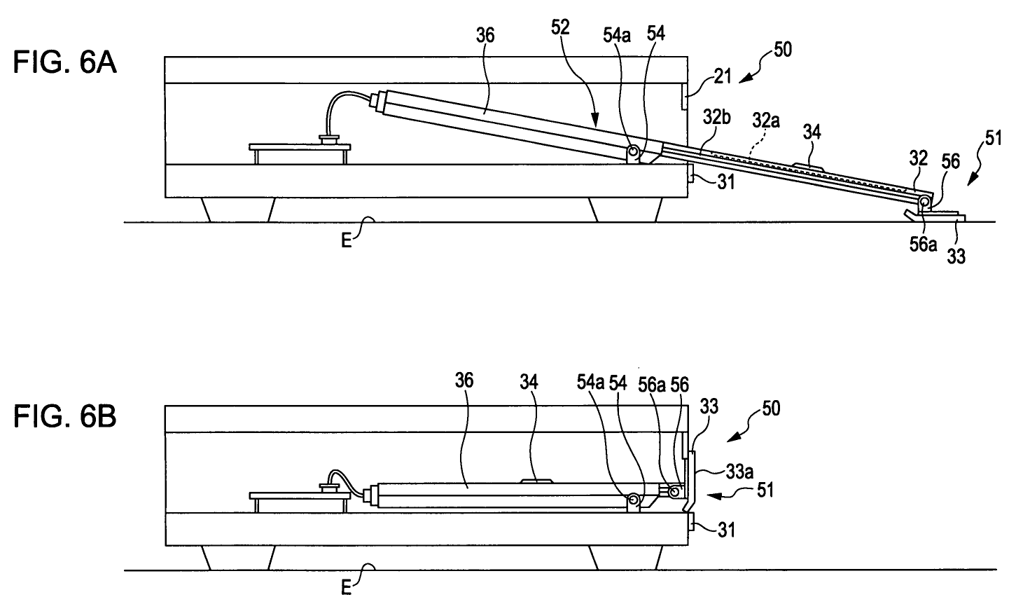

A second embodiment of the invention will be described with reference to the drawings. FIGS. 6A and 6B show another disk drive 50, wherein FIG. 6A shows the disk drive 50 in which the disk tray 32 is in the disk loading position and FIG. 6B shows the disk drive 50 in which the disk tray 32 is in the housing position. The disk drive 50 includes a grounding support section 51 provided at the second end of the disk tray 32, for supporting the disk tray 32 from below when the disk tray 32 is in the disk loading position and a grounding mechanism 52 for bringing the grounding support section 51 into or out of contact with the grounding surface E. The grounding mechanism 52 has a guide 36 that guides the disk tray 32 into or out of the casing 21 and a guide support member 54 that supports the guide 36 rotatably about a support shaft 54a so that the second end of the disk tray 32 moves toward the grounding surface E. In the disk drive 50, the disk tray 32 is heavier at the second end than at the first end, so that the second end of the disk tray 32 tilts to the grounding surface E with respect to the support shaft 54a when it is in the disk loading position. The bezel 33 is disposed at the second end of the disk tray 32 via a rotating section 56 that supports the bezel 33 rotatably about a grounding shaft 56a. Accordingly, the bezel 33 rotates such that the outer surface 33a, which is exposed to the exterior when the disk tray 32 is in the housing position, comes into contact with the grounding surface E.

With this disk drive 50, as shown in FIG. 6A, when the user pushes the disk tray 32 toward the casing 21 with the bezel 33 with the disk tray 32 in the disk loading position, then the disk tray 32 is moved into the casing 21 by the guide 36. At that time, the disk tray 32 is moved while rotating about the support shaft 54a of the guide support member 54. The bezel 33 rotates about the grounding shaft 56a so that the outer surface 33a faces the front, and the disk tray 32 is fixed in the housing position with a locking mechanism (not shown). On the other hand, when the open switch 31 is pushed down when the disk tray 32 is in the housing position, as shown in FIG. 6B, the disk tray 32 is moved from the interior of the casing 21 to the outside by the guide 36. At that time, the disk tray 32 moves such that the second end tilts to the grounding surface E about the support shaft 54a. When the lower part of the bezel 33 comes into contact with the grounding surface E, the bezel 33 rotates about the grounding shaft 56a to bring the outer surface 33a into contact with the grounding surface E. Thus, when the disk tray 32 is in the disk loading position, the bezel 33 at the second end of the disk tray 32 is in contact with the grounding surface E to support it, and the guide support member 54 at the first end of the disk tray 32 supports it in the casing 21. This structure can prevent troubles due to a load from above more than a structure in which the second end of the disk tray 32 is not grounded. This structure allows the disk tray 32 to be grounded with a relatively simple structure. Since the disk tray 32 can be rotated by the guide support member 54 relatively freely, the bezel 33 can easily be grounded even if the grounding surface E has unevenness, thus allowing the disk tray 32 to be supported with higher stability.

### Third Embodiment

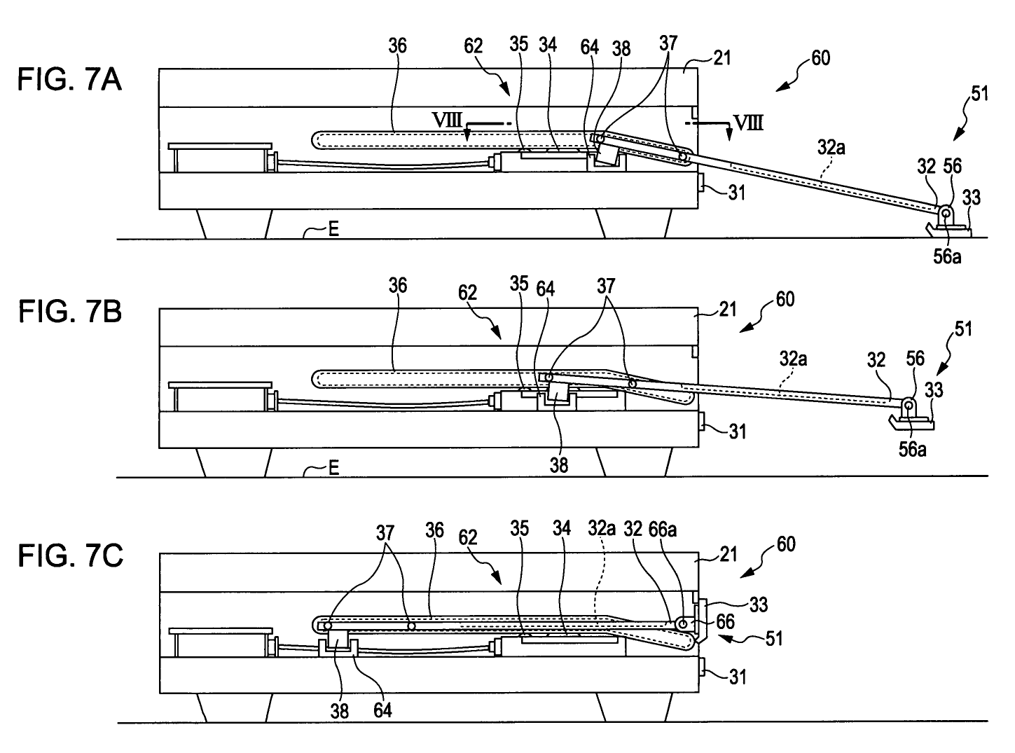

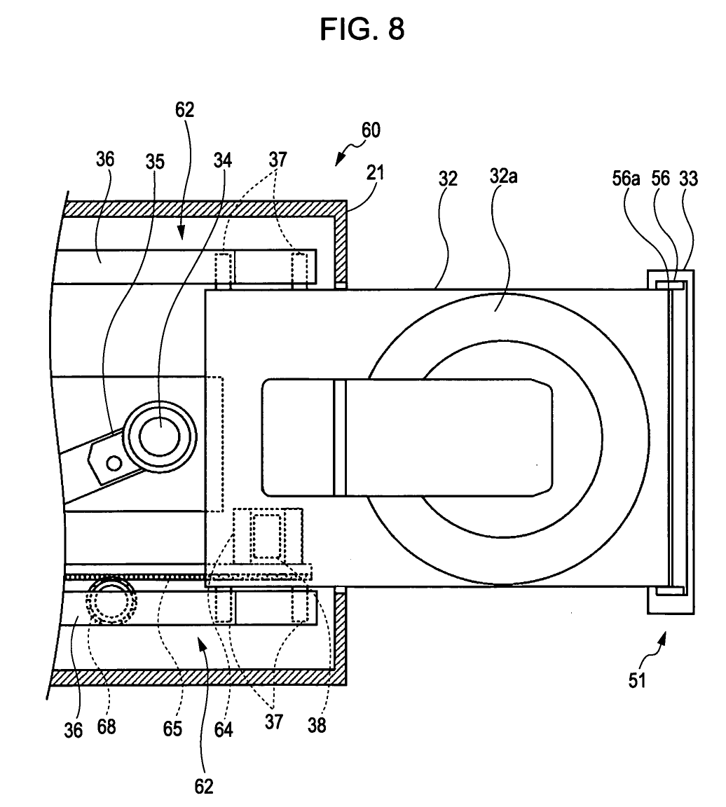

A third embodiment of the invention will be described with reference to the drawings. FIGS. 7A to 7C show another disk drive 60, wherein FIG. 7A shows the disk drive 60 in which the disk tray 32 is in a loading position, FIG. 7B shows the disk drive 60 in which the disk tray 32 is moving, and FIG. 7C shows the disk drive 60 in which the disk tray 32 is in the housing position. FIG. 8 is a sectional view of the disk drive 60 taken along line VIII-VIII of FIG. 7A. The disk drive 60 has a disk tray 32 having a plurality of guide pins 37 (in this case, two each) on both sides thereof adjacent the first end and a rectangular-solid locking section 38 on the lower surface thereof adjacent the first end; a grounding support section 51 disposed at the second end of the disk tray 32 to support the disk tray 32 from below when the disk tray 32 is in the disk loading position; a guide 36 that guides the disk tray 32 from the interior of the casing 21 toward the grounding surface E; and a grounding mechanism 62 that moves the disk tray 32 between the disk loading position and the housing position by engagement with the locking section 38. The guide 36 is horizontal in the casing 21 and inclines downward in the vicinity of an opening through which the disk tray 32 passes. The grounding mechanism 62 includes a moving section 64 in which the locking section 38 is fitted, a guide 65 for guiding the moving section 64, and a moving gear 68 for moving the guide 65. The moving section 64 has a U-shape cross section in the moving direction of the disk tray 32, in which the locking section 38 is fitted from above with clearance therebetween. As shown in FIG. 8, the rectangular guide 65 having a gear is fixed to one side of the guide 65. The gear of the guide 65 engages with the moving gear 68. The moving gear 68 is driven by a motor (not shown) to move the disk tray 32 between the disk loading position and the housing position. The disk tray 32 has not the chucking section 34 and the pickup section 35. The pickup section 35 is disposed in the casing 21.

With this disk drive 60, when the user pushes the open switch 31 with the disk tray 32 in the disk loading position as shown in FIG. 7A, the motor (not shown) is driven to rotate the moving gear 68 (see FIG. 8) to move the moving section 64 to the rear of the casing 21 with the guide 65. As the moving section 64 moves, the locking section 38 fitted in the moving section 64 is moved, so that the disk tray 32 is moved to the casing 21. At that time, the guide pins 37 on both sides of the disk tray 32 are guided by the guide 36, so that the disk tray 32 is moved while the second end is floating from the grounding surface E, as shown in FIG. 7B. When the disk tray 32 reaches the housing position, the lower part of the bezel 33 comes into contact with the casing 21, so that the bezel 33 rotates to cover the opening. On the other hand, when the open switch 31 is pushed down when the disk tray 32 is in the housing position, as shown in FIG. 7C, the moving section 64 is moved toward the opening by the rotation of the moving gear 68 driven by the motor (not shown). Thus, the disk tray 32 to which the locking section 38 is fixed is guided by the guide 36 to move from the interior of the casing 21 to the outside. At that time, the disk tray 32 is moved while the second end is tilted to the grounding surface E by the guide 36. When the lower part of the bezel 33 comes into contact with the grounding surface E, as shown in FIG. 7A, the bezel 33 rotates about the grounding shaft 56a to bring the outer surface 33a into contact with the grounding surface E. Thus, when the disk tray 32 is in the disk loading position, the bezel 33 at the second end of the disk tray 32 comes into contact with the grounding surface E to support the disk tray 32, and the guide pins 37 at the first end of the disk tray 32 support the disk tray 32 from the casing 21. This structure can prevent troubles due to a load from above more than a structure in which the second end of the disk tray 32 is not grounded. This structure allows the disk tray 32 to be grounded with a relatively simple structure.

It is to be understood that the invention is not limited to the above-described embodiments and various modifications can be made without departing from the technical scope of the invention.

For example, although the grounding member of the first embodiment is the grounding roller 43, it may not be limited to the roller but may be a flat plate.

Although the grounding roller 43 is urged to come into contact with the grounding surface by urging the first member 41 and the second member 42 by the spring 44 connected to the first member 41 and the second member 42, the rotating end of the first member 41 may be urged to the grounding surface using a spring connected to the guide 36 and the first member 41, or alternatively, the connecting end of the second member 42 may be urged to the grounding surface by a spring connected to the guide 36 and the second member 42. This also allows the grounding roller 43 to be urged to the grounding surface. As an alternative, the spring 44 may be omitted. This simplifies the structure.

Although the grounding roller 43 of the first embodiment is disposed at a position vertically below the chucking section 34 when the disk tray 32 is in the disk loading position, the invention is not limited to that; the grounding roller 43 may be disposed at any position below the disk tray 32. It is preferable that the grounding roller 43 be disposed at a position vertically below the chucking section 34 or at the second end of the disk tray 32 in consideration of the stability of the disk tray 32.

Although the disk tray 32 of the first and second embodiments is moved by the urging force of a spring, the disk tray 32 may be moved to the disk loading position by the driving force of a motor as in the third embodiment. As an alternative, the user may retract or push the disk tray 32 or the grounding roller 43 without using a spring.

Although the chucking section 34 of the first and second embodiments is provided on the disk tray 32, it may not be disposed on the disk tray 32. Although the pickup section 35 of the first and second embodiments is disposed on the disk tray 32, it may be disposed in the casing 21. This also prevents troubles due to a load from above on the disk tray 32.

Although the grounding member of the second and third embodiment is the rotatable bezel 33, it may be an unrotatable bezel. This also allows the lower part of the bezel to come into contact with the grounding surface to support the disk tray 32. The grounding member may not be the bezel 33 but another grounding member may be provided at a position other than the second end. The grounding member may not necessarily be a flat plate but may be a grounding roller.

In the foregoing embodiments, the first embodiment is configured such that the disk tray 32 is moved horizontally between the disk loading position and the housing position, and the second and third embodiments are configured such that the disk tray 32 is moved toward the grounding surface into the disk loading position. The first embodiment may also be configured such that the disk tray 32 is moved toward the grounding surface into the disk loading position. Thus, the structures of the first, second, and third embodiments may be selected or combined as appropriate.

Although the foregoing embodiments have been described using the printer 20 equipped with the disk drive 30, the invention may be applied to any electrooptic devices equipped with the disk drive 30. For example, the invention can be applied to PCs, recording decks (optical disk decks), audio equipment, and game machines. The invention may be a single disk drive 30 (an external disk drive). The disk to be loaded on the disk tray 32 may be housed in a rectangular case.

What is claimed is:

1. A disk drive comprising:
a disk tray having a disk loading surface on the top;
a moving mechanism that guides the disk tray between a disk-tray housing position in the casing and a disk loading position outside the casing; and
a grounding support section having a grounding member that comes into contact with a grounding surface below the disk tray to support the disk tray when the disk tray is brought into the disk loading position by the moving mechanism.

2. The disk drive according to claim 1, wherein the grounding support section includes a grounding mechanism having the grounding member, wherein when the disk tray is in the housing position, the grounding mechanism fixes the grounding member to the lower surface of the disk tray, and when the disk tray is in the disk loading position, the grounding mechanism fixes the grounding member to the grounding surface.

3. The disk drive according to claim 2, wherein the grounding mechanism includes a first support member one end of which is rotatably fixed to the lower surface of the disk tray and the other rotatable end of which has the grounding member; and a second support member shorter than the first support member and having a connecting end connected to the rotatable end of the first support member and a moving end disposed so as to move along the lower surface of the disk tray.

4. The disk drive according to claim 3, wherein the grounding mechanism includes a first urging section that urges at least one of the first and second support members to the grounding surface; and a second urging member that urges at least one of the first and second support members to the lower surface of the disk tray when the disk tray is in the housing position.

5. The disk drive according to claim 4, wherein:
the moving mechanism includes a guide movable between the interior and the outside of the casing so as to guide the disk tray between the interior and the outside of the casing;
the fixed end of the first support member is rotatably disposed at a first end of the guide adjacent to the casing;
the moving end of the second support member is disposed at a second end of the guide so as to be movable to the fixed end; and
the second urging member is disposed at the disk tray and, when the disk tray moves from the disk loading position to the housing position, urges the first and second support members to the lower surface of the disk tray by urging the moving end of the second support member to the fixed end of the first support member.

6. The disk drive according to claim 1, wherein
the disk tray includes a chucking section that holds the disk; and
the grounding support section is configured such that the grounding member comes to a position vertically below the chucking section when the disk tray is in the disk loading position.

7. The disk drive according to claim 1, wherein the moving mechanism includes a guide that guides the disk tray between the interior and the outside of the casing and a guide support member that rotatably supports the guide so that the second end of the disk tray moves to the grounding surface.

8. The disk drive according to claim 1, wherein the moving mechanism is a guide that guides the disk tray from the interior of the casing to the grounding surface.

9. The disk drive according to claim 7, wherein the grounding support section is a bezel having the grounding member at the second end of the disk tray.

10. The disk drive according to claim 9, wherein the bezel is rotatable about a rotation shaft at the second end of the disk tray so that the outer surface of the bezel that is exposed to the outside when the disk tray is in the housing position comes into contact with the grounding surface when the disk tray comes to the disk loading position.

11. The disk drive according to claim 1, wherein the grounding support section is a grounding roller in which the grounding member crawls over the grounding surface.

12. The disk drive according to claim 1, wherein the grounding support section includes a first pushing member that pushes the grounding member against the grounding surface; and a second pushing member that pushes the grounding member to the lower surface of the disk tray by the moving mechanism when the disk tray is in the housing position.

13. A printer comprising:
the disk drive according to claim 1; and
a print processing unit that can print data read from a disk loaded on the disk drive to a print medium.
